(19) United States
(12) Patent Application Publication
(10) Pub. No.: US 2007/0085657 A1
(43) Pub. Date: Apr. 19, 2007

(54) Portable device for keyless entry system of motor vehicle

(75) Inventor: Katsuhisa Ogino, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/545,705

(22) Filed: Oct. 11, 2006

(30) Foreign Application Priority Data
Oct. 13, 2005 (JP) 2005-298548

(51) Int. Cl. G05B 19/00

(52) U.S. Cl. 340/5.64; 340/5.72

(57) ABSTRACT

The portable device includes a control part for authenticating with an on-vehicle keyless control device by communication therewith to lock/unlock a door, a receiving part for receiving a radio signal from the control device, a transmitting part for outputting a response signal to the control device, a sender judging part for judging whether the radio signal comes from an interior transmitting antenna of the motor vehicle or from an exterior transmitting antenna thereof, and an output control part for changing an output power of the transmitting part based on a judgment result of the judging part so that the output power is decreased when the judging part judges the radio signal to come from the interior transmitting antenna, relative to an output power outputted when the judgment part judges the radio signal to come from the exterior transmitting antenna.

### BACKGROUND OF THE INVENTION

1. Field of the Invention

The present invention relates to a portable device for a keyless entry system of a motor vehicle in which a door can be locked and unlocked by using wireless communication between an on-vehicle keyless entry system and a portable device.

2. Description of the Related Art

A portable device for a keyless entry system of a motor vehicle, of this kind is disclosed in Japanese patent laying-open publication No. 2003-269019. This portable device outputs an identification (ID) code via high-frequency radio waves to an on-vehicle transmitting and receiving device when its keyless circuit receives a request signal via low-frequency radio waves from the on-vehicle transmitting and receiving device. The portable device also outputs the identification code via low-frequency radio waves to the on-vehicle transmitting and receiving device when an transponder of the portable device receives a low-frequency electromagnetic waves for electric power. After this authentication of the ID code, doors of a motor vehicle are locked or unlocked and an engine can be started. This conventional keyless entry system (a smart entry system) with a smart ignition system is constructed so that a user can start engine by placing the portable device into a recess formed on a front surface side of an instrument panel even when a battery of the portable device is almost exhausted.

The above known conventional portable device, however, encounters a problem in that consumption of electric power is large in the battery of the portable device, accordingly the battery being exhausted in a short time, because its output level of transmitting radio waves is fixed. The consumption of the electric power becomes larger when the portable device has a remote-operation function.

It is, therefore, an object of the present invention to provide portable device, adapted for a keyless entry system of a motor vehicle, which overcomes the foregoing drawbacks and can decrease consumption of electric power of a battery contained in a portable device and extend battery life thereof.

### SUMMARY OF THE INVENTION

According to a first aspect of the present invention there is provided a portable device for a keyless entry system of a motor vehicle, the portable device includes a control part that is capable of authenticating with an on-vehicle keyless control device by communication with the on-vehicle keyless control device to lock/unlock a door of a motor vehicle, a receiving part for receiving a radio signal outputted from the on-vehicle keyless control device, a transmitting part for outputting a response signal to the on-vehicle keyless control device, a sender judging part for judging whether the radio signal comes from an interior transmitting antenna provided on the motor vehicle or from an exterior transmitting antenna provided on the motor vehicle, and an output control part that is capable of changing an output power of the transmitting part based on a judgment result of the sender judging part so that the output power is decreased when the sender judging part judges the radio signal to come from the interior transmitting antenna, relative to an output power of the transmitting part when the sender judging part judges the radio signal to come from the exterior transmitting antenna.

In this portable device, the output control device decreases the output power of the transmitting part when the radio signal is received, which can decrease consumption of electric power of a battery contained in a portable device and extend battery life thereof.

Preferably, the sender judging part judges the radio signal to come from the interior transmitting antenna when the radio signal is kept received at a receiving intensity larger than a predetermined value for more than a predetermined time.

Therefore, the sender judging part can judge from which of the interior transmitting antenna and the exterior transmitting antenna the radio signal comes without an outstanding increase in its manufacturing costs.

Preferably, the interior transmitting antenna and the exterior transmitting antenna output the radio signals different from each other in frequency, and the sender judging part judges whether the radio signal comes from the interior transmitting antenna or from the exterior transmitting antenna, based on the frequency of the radio signal received by the receiving part.

Therefore, the sender judging part can judge from which of the interior transmitting antenna and the exterior transmitting antenna the radio signal comes without an outstanding increase in its manufacturing costs.

Preferably, the portable device further includes an operation part that is remote-operatable by a user to output a remote-operation signal. The output changing part prevents the output power from being decreased when the remote-operation signal is transmitted.

Therefore, the portable device ensures the communication with the on-vehicle keyless control device when the remote-operation is carried out by the user.

### BRIEF DESCRIPTION OF THE DRAWINGS

The objects, features and advantages of the present invention will become apparent as the description proceeds when taken in conjunction with the accompanying drawings, in which:

FIG. 1 is a view showing a keyless entry system including a portable device of a first embodiment according to the present invention, an on-vehicle keyless control device and an on-vehicle door lock device; and

FIG. 2 is a flow chart of a process of communication between the portable device and the keyless control device, which is executed by the portable device.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

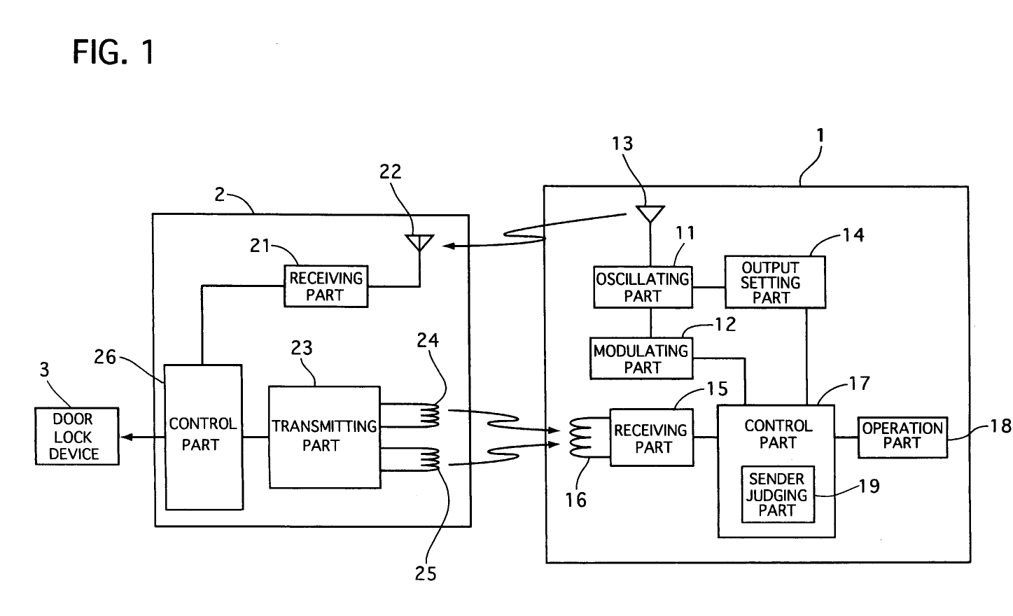

Referring to FIG. 1 of the drawing, there is shown a first preferred embodiment of a keyless entry system of a motor vehicle, including portable device according to the present invention.

The keyless entry system includes a portable device 1, an on-vehicle keyless control device 2 which can communicate with the portable device 1, and an on-vehicle door lock device 3 which is controlled by the on-vehicle keyless control device 2.

The portable device 1 can be carried around inside and outside a motor vehicle with a user such as a driver, and is used for operating the on-vehicle keyless control device 2 to lock/unlock doors of the motor vehicle. The portable device 1 has an oscillating part 11, a modulating part 12, a transmitting antenna 13, an output setting part 14, a receiving part 15, a receiving antenna 16, a control part 17, and an operation part 18.

The transmitting antenna 13 is electrically connected to the oscillating part 11 to receive a radio signal from the oscillating part 11 and emit electric waves.

The oscillating part 11 is electrically connected to the modulating part 12, the transmitting antenna 13 and the output setting part 14 to receive a radio wave signal and an output setting signal from the modulating part 12 and the output setting part 14, respectively, and output the radio signal to the transmitting antenna 13. The radio signal is outputted from the oscillating part 11 at a radio field intensity determined by the output setting signal obtained from the output setting part 14.

The modulating part 12 is electrically connected to the oscillating part 11 and the control part 17 to receive an information signal from the control part 17 and modulate it to the radio wave signal, then outputting the radio wave signal to the oscillating part 11. Incidentally, the oscillating part 11 and the modulating part 12 act as a transmitting part of the present invention.

The output setting part 14 is electrically connected to the oscillating part 11 and the control part 17 to receive a command signal from the control part 17 and output an output setting signal to the oscillating part 11. The output setting signal is determined based on the command signal so that the oscillating part 11 can change its output power of the radio signal based on the output setting signal.

The receiving antenna 16 is electrically connected to the receiving part 16 to receive a radio wave signal outputted from the on-vehicle keyless control device 2 and send it to the receiving part 15.

The receiving part 15 is electrically connected to the receiving antenna 16 and the control part 17 to receive the radio wave signal from the on-vehicle keyless control device 2 and change it into an information signal, then outputting the information signal to the control part 17.

The control part 17 is electrically connected to the receiving part 15, the output setting part 14 and the operation part 18 to receive the information signal and an operation signal from the receiving part 15 and the operation part 18, respectively, and execute various control process of the portable device 1 based on the information signal and the operation signal. The control part 17 includes a sender judging part 19 for judging, based on a receiving intensity of the radio waves received by the receiving part 15 and its elapsed time, where the radio waves come, from an interior transmitting antenna 24 provided in the motor vehicle or from an exterior transmitting antenna 25 provided thereon. The control part 17 outputs the command signal for decreasing an output level of the radio waves to be transmitted when it judges that the receiving signal is emitted from the interior transmitting antenna 24. In addition, when the user operates the operation part 18, the control part 17 outputs an information signal according to the operation signal inputted from the operation part 18 to the modulating part 12. Incidentally, the control part 17 and the output setting part 14 act as an output control part of the present invention.

The operation part 18 is electrically connected to the control part 17 to output the remote-operation signal inputted by the user to the control part 17.

On the other hand, the keyless control device 2 is installed on the motor vehicle, and includes a receiving part 21, a receiving antenna 22, a transmitting part 23, the interior transmitting antenna 24, the exterior transmitting antenna 25, and a control part 26.

The receiving antenna 22 is electrically connected to the receiving part 21 to receive the radio waves outputted from the transmitting antenna 13 of the portable device 1 and send it to the receiving part 21.

The receiving part 21 is electrically connected to the receiving antenna 22 and the control part 26 to receive the radio waves and change it into an information signal, then outputting the information signal to the control part 26.

The transmitting part 23 is electrically connected to the control part 26, the interior transmitting antenna 24 and the exterior transmitting antenna 25 to receive an information signal and change it into a radio signal, then emitting it from the interior transmitting antenna 24 and the exterior transmitting antenna 25.

The interior transmitting antenna 24 is installed on an inner-side member of the motor vehicle and electrically connected to the transmitting part 23 to receive an ID request signal and emit it.

The exterior transmitting antenna 25 is installed on an outer-side member of the motor vehicle and electrically connected to the transmitting part 23 to receive the ID request signal and emit it. Incidentally, the interior transmitting antenna 24 and the exterior transmitting antenna 25 are constructed and provided, for example, similarly to those of Japanese patent laying-open publication No. 2003-269019.

The control part 26 is electrically connected to the receiving part 21, the transmitting part 23 and the door lock device 3 to receive the information signal from the receiving part 21 and output the lock/unlock signal to the door lock device 3. The control part 26 outputs the ID request signal to the interior transmitting antenna 24 and the exterior transmitting antenna 25 according to need.

ID code is set to be distinguishable among those of motor vehicles and stored in the portable device 1 and the on-vehicle keyless control device 2. The portable device 1 and the on-vehicle keyless control device 2 communicate with each other to authenticate the ID code by checking it.

The door lock device 3 is provided on the motor vehicle and includes at least an electric motor or a solenoid, for locking and unlocking the doors of the motor vehicle, and a controller for controlling the electric motor or the solenoid. The door lock device 3 is electrically connected to the control part 26 of the on-vehicle device 2 to receive a lock/unlock signal from the control part 26 and lock/unlock the doors.

Incidentally, not-shown request switches are provided in vicinity of door knobs of the motor vehicle, respectively. The request switch may be one, and is preferably provided in vicinity of a door knob of a driver's door in this case. Lock/unlock of the doors can be carried out when the user operates one of the request switches or the operation part 18 of the portable device 1.

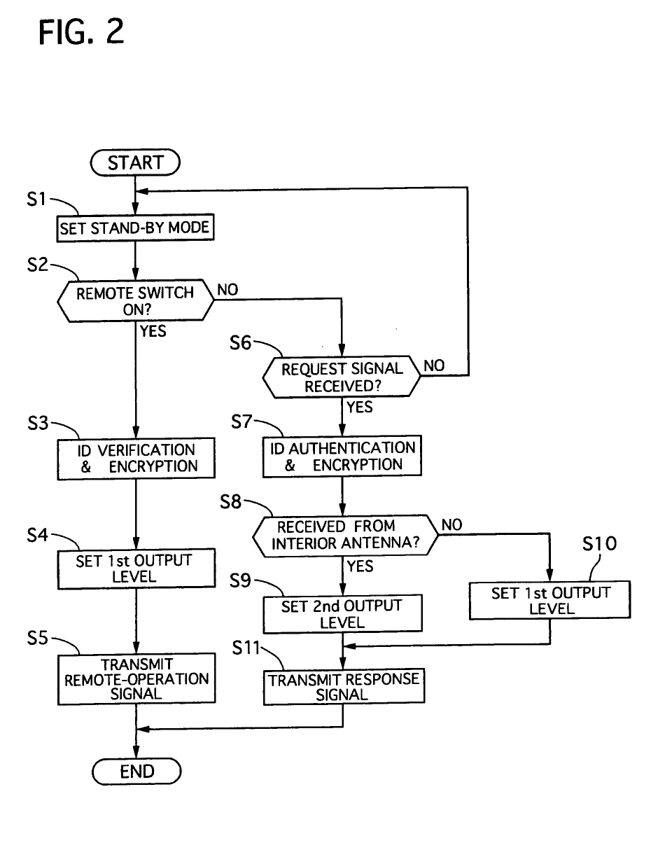

The operation of the keyless entry system including the portable device 1 will be described with reference to the accompanying drawings of FIGS. 1 and 2.

The portable device 2 executes a communication process according to a flow chart shown in FIG. 2 as follows.

At step S1 the portable device 1 is set in a stand-by mode where various functions are ready to work, and then the flow goes to step S2.

At the step S2, the control part 17 judges, based on a remote-operation signal outputted from the operation part 18, whether or not it is operated to be inputted. If YES, the flow goes to step S3, while, if NO, the flow goes to step S6.

At step the S3, the control part 17 executes an ID verification process and an encryption process of transmitting data to be sent, and then the flow goes to step S4.

At the step S4, the output setting part 14 sets an output setting level to be a first output level, which can provide a larger output of the radio waves to be emitted, and then the flow goes to step S5.

At the step S5, the oscillating part 11 outputs a radio signal to the transmitting antenna 13, where the transmitting antenna 13 emit the radio waves representing a remote-operation command inputted into the operation part 18 by the user, and then the communication process is finished.

At the step S6, the control part 17 judges, based on a radio wave signal outputted from the on-vehicle keyless control device 2, whether or not the portable device 1 receives a request signal therefrom. If YES, the flow goes to step S7, while, if NO, the flow returns to step S1.

At the step S7, the control part 17 carries out an ID authentication process based on the radio wave signal outputted from the receiving part 16, also carrying out the encryption process of transmitting data to be sent, and then the flow goes to step S8.

At the step S8, the sender judging part 19 of the control part 17 judges, based on the radio wave signal outputted from the receiving part 16, whether this caught radio wave waves come from the interior transmitting antenna 24 of the motor vehicle or from the exterior transmitting antenna 25 thereof. If it judges that they come from the interior transmitting antenna 24, the flow goes to step S9, while, if it judges that they come from the exterior transmitting antenna 25, the flow goes to step S10.

At the step S9, the output setting part 14 sets an output setting signal to be the second output level for providing an output of the transmitting radio waves smaller than that at the first output level, and then the flow goes to step S11.

At the step S10, the output setting part 14 sets the output setting signal to be the first output level for providing the output of the transmitting radio waves larger than that at the second output level, and then the flow goes to the step S11.

At the step S11, the control part 17 controls the modulating part 12 and the oscillating part 11 to send a response signal through the transmitting antenna 13 in response to a request signal received from the on-vehicle keyless control device 2, and then the communication process is finished.

The portable device 1 executes the above-described flow chart, and accordingly can decrease its electric power consumption of a battery contained in the portable device 1 as follows.

In the portable device 1 of the embodiment used in the keyless entry system, the portable device 1 judges whether or not the operation part 18 is operated to be inputted by the user as shown in the step S1. When it is operated, the portable device 1 sends the ID data, which is distinguishable by the portable device 1 and the on-vehicle keyless control device 2, to the on-vehicle keyless control device 2, where the ID data is verified. When it is verified, the portable device 1 emits an encrypted remote-operation signal as shown in the steps S3 to S5. In this process, the output setting part 14 sets the first output level as shown in the step S4. This ensures the portable device 1 to remotely operate the on-vehicle keyless control device 2.

On the other hand, when a request signal is generated, for example, by pressing the request switch located on the motor vehicle by the user, the on-vehicle keyless control device 2 sends a request signal to the portable device 1. The portable device 1 receives the request signal to send the ID data to the on-vehicle keyless control device 2, where it is checked. When it is authenticated, the portable device 1 sends an encrypted response signal to the on-vehicle keyless control device as shown in the steps S7 to S11. In this process, the sender judging part 19 of the portable device 1 judges whether the received signal comes from the interior transmitting antenna 24 or from the exterior transmitting antenna 25 as shown in the step S8.

In this embodiment, the sender judging part 19 judges that the received signal comes from the interior transmitting antenna 24 when a receiving intensity of the received signal continues at a level larger than a predetermined level for more than a predetermined time, since the user is usually near a door in this case. That is, a location relationship between the portable device 1 and the interior transmitting antenna 24 is substantially fixed, and they are kept within a predetermined distance (near a door). This judgment method can distinguish where the received signal comes: from the interior transmitting antenna 24 or from the exterior transmitting antenna 25 without outstanding increase in manufacturing costs of the portable device 1.

When the sender judging part 19 judges that the received signal comes from the interior transmitting antenna 24 in the step S8, the output setting part 14 sets the output setting signal to be the second output level as shown in the step S9 and decreases the output power of the radio waves to be outputted from the transmitting antenna 13. This reduction in the output power of the radio waves ensures the electric power consumption of the battery contained in the portable device 1 to be decreased when it emits the radio waves, accordingly extending battery life of the portable device 1.

When the remote operation from the portable device 1 is needed, the output power of the radio waves is increased up to a necessary value.

After the communication process, the control part 26 of the on-vehicle keyless control device 2 controls the door lock device 3 to lock or unlock the doors.

The portable device 1 of the embodiment has the following advantages.

In the portable device 1, the sender judging part 19 of the portable device 1 judges, based on the received signal, whether it comes from the interior transmitting antenna 24 or from the exterior transmitting antenna 25, and the output setting part 14 sets the output setting signal according to its judgment result to vary the output power of the radio waves outputted from the transmitting antenna 13. This can decrease the electric power consumption of the battery contained in the portable device 1, extending the battery life of the portable device 1.

The sender judging part 19 judges the received radio signal to come from the interior transmitting antenna 24 when the radio signal is kept being received at the receiving intensity larger than the predetermined value for more than the predetermined time. This enables the sender judging part 19 to judge whether the received radio signal comes from the interior transmitting antenna 24 or from the exterior transmitting antenna 25 without outstanding increase in its manufacturing costs of the portable device 1.

The output setting part 14 sets the output setting signal to be the first level when the user operates the operation part 18 for remote operation. This ensures communication between the portable device 1 and the on-vehicle keyless control device 2 by remote operation.

While there have been particularly shown and described with reference to preferred embodiments thereof, it will be understood that various modifications may be made therein, and it is intended to cover in the appended claims all such modifications as fall within the true spirit and scope of the invention.

For example, frequencies of the radio signals emitted from the interior transmitting antenna 24 and the exterior transmitting antenna 25 may be set different from each other, and the sender judging part 19 may judge a sender of the received radio signal based on the frequency thereof.

In this embodiment, the keyless entry system is provided, but functions of the system of the present invention are not limited only to Lock/Unlock of the doors. A function of permitting engine start and/or other functions may be added to the system.

The entire contents of Japanese Patent Application No. 2005-298548 filed Oct. 13, 2006 are incorporated herein by reference.

What is claimed is:

1. A portable device for a keyless entry system of a motor vehicle, the portable device comprising:
a control part that is capable of authenticating with an on-vehicle keyless control device by communication with the on-vehicle keyless control device to lock/unlock a door of a motor vehicle;
a receiving part for receiving a radio signal outputted from the on-vehicle keyless control device;
a transmitting part for outputting a response signal to the on-vehicle keyless control device;
a sender judging part for judging whether the radio signal comes from an interior transmitting antenna provided on the motor vehicle or from an exterior transmitting antenna provided on the motor vehicle; and
an output control part that is capable of changing an output power of the transmitting part based on a judgment result of the sender judging part so that the output power is decreased when the sender judging part judges the radio signal to come from the interior transmitting antenna, relative to an output power of the transmitting part when the sender judging part judges the radio signal to come from the exterior transmitting antenna.

2. The portable device according to claim 1, wherein
the sender judging part judges the radio signal to come from the interior transmitting antenna when the radio signal is kept received at a receiving intensity larger than a predetermined value for more than a predetermined time.

3. The portable device according to claim 2, further comprising
an operation part that is remote-operatable by a user to output a remote-operation signal, wherein
the output changing part prevents the output power from being decreased when the remote-operation signal is transmitted.

4. The portable device according to claim 1, wherein
the interior transmitting antenna and the exterior transmitting antenna output the radio signals different from each other in frequency, and
the sender judging part judges whether the radio signal comes from the interior transmitting antenna or from the exterior transmitting antenna, based on the frequency of the radio signal received by the receiving part.

5. The portable device according to claim 4, further comprising
an operation part that is remote-operatable by a user to output a remote-operation signal, wherein
the output changing part prevents the output power from being decreased when the remote-operation signal is transmitted.

6. The portable device according to claim 1, further comprising
an operation part that is remote-operatable by a user to output a remote-operation signal, wherein
the output changing part prevents the output power from being decreased when the remote-operation signal is transmitted.
